(19) United States
(12) Patent Application Publication
(10) Pub. No.: US 2022/0391245 A1
(43) Pub. Date: Dec. 8, 2022

(54) INFORMATION PROCESSING APPARATUS

(71) Applicant: Sony Interactive Entertainment Inc., Tokyo (JP)

(72) Inventors: Masatoshi Nakae, Tokyo (JP); Yoshiyuki Imada, Tokyo (JP)

(73) Assignee: Sony Interactive Entertainment Inc., Tokyo (JP)

(21) Appl. No.: 17/775,275

(22) PCT Filed: Sep. 29, 2020
(86) PCT No.: PCT/JP2020/036905

§ 371 Date: May 7, 2022

(30) Foreign Application Priority Data
Nov. 19, 2019 (JP) 2019-209140

(51) Int. Cl. G06F 9/48; G06F 3/01

(52) U.S. Cl. CPC G06F 9/4881; G06F 3/016

(57) ABSTRACT

An information processing apparatus that executes a plurality of processes in parallel and transmits, to an operation device connected thereto, a control instruction indicating the content of a control process to be executed by the operation device, the information processing apparatus transmitting a control instruction according to a setting request received from a selected process which has been selected from among the plurality of processes according to a given condition and restricting the transmission of a control instruction according to a setting request received from a process other than the selected process.

### TECHNICAL FIELD

The present invention relates to an information processing apparatus that executes processing according to operation information received by an operation device, a control method thereof, and a program.

### BACKGROUND ART

There are cases where an information processing apparatus causes the operation device connected thereto to execute various types of control such as operation feedback and generation of vibration. Each process executed by the information processing apparatus causes the operation device to execute an operation according to a content of the process executed by itself, by requesting the operation device to execute such control.

### [SUMMARY] [TECHNICAL PROBLEM]

However, in the case where a plurality of processes executed in parallel each attempt to request the operation device to execute control, there is a risk that the requests may conflict.

The present invention has been made in consideration of the above circumstances, and one of the objects thereof is to provide an information processing apparatus capable of avoiding conflict of control requests with respect to an operation device, a control method thereof, and a program.

### Solution to Problem

The information processing apparatus according to one aspect of the present invention is an information processing apparatus connected to an operation device, and includes a process executing section that executes a plurality of processes in parallel, and an operation device control section that transmits, to the operation device, a control instruction that indicates a content of the control process to be executed by the operation device, in which the operation device control section transmits the control instruction in response to a setting request received from a selected process selected from the plurality of processes according to a given condition, and restricts transmission of the control instruction in response to a setting request received from a process different from the selected process.

The control method of the information processing apparatus according to one aspect of the present invention is a control method of the information processing apparatus connected to an operation device, and includes a step of executing a plurality of processes in parallel and a step of transmitting, to the operation device, a control instruction indicating a content of the control process to be executed by the operation device, in which the step of transmitting includes transmitting the control instruction in response to a setting request received from a selected process selected from the plurality of processes according to a given condition and restricting transmission of the control instruction in response to a setting request received from a process different from the selected process.

The program according to one aspect of the present invention is a program that causes a computer connected to an operation device to execute a step of executing a plurality of processes in parallel and a step of transmitting, to the operation device, a control instruction indicating a content of the control process to be executed by the operation device, in which the step of transmitting includes transmitting the control instruction in response to a setting request received from a selected process selected from the plurality of processes according to a given condition and restricting transmission of the control instruction in response to a setting request received from a process different from the selected process. This program may be provided while stored in a computer-readable non-transitory information storage medium.

### BRIEF DESCRIPTION OF DRAWINGS

FIG. 1 is an overall configuration diagram of an information processing system.

FIG. 2 is a diagram illustrating an example of an external appearance of an operation device.

FIG. 3 is a functional block diagram illustrating functions fulfilled by the information processing system.

FIG. 4 is a diagram illustrating an example of a state transition in an operation mode.

FIG. 5 is a flow chart illustrating an example of the processing flow in the case where one process is executed.

FIG. 6A is a flow chart which illustrates an example of the processing flow in the case where a plurality of processes are executed in parallel.

FIG. 6B is a flow chart which illustrates an example of the processing flow in the case where a plurality of processes are executed in parallel.

### DESCRIPTION OF EMBODIMENT

Hereinafter, an embodiment of the present invention will be described in detail with reference to the drawings.

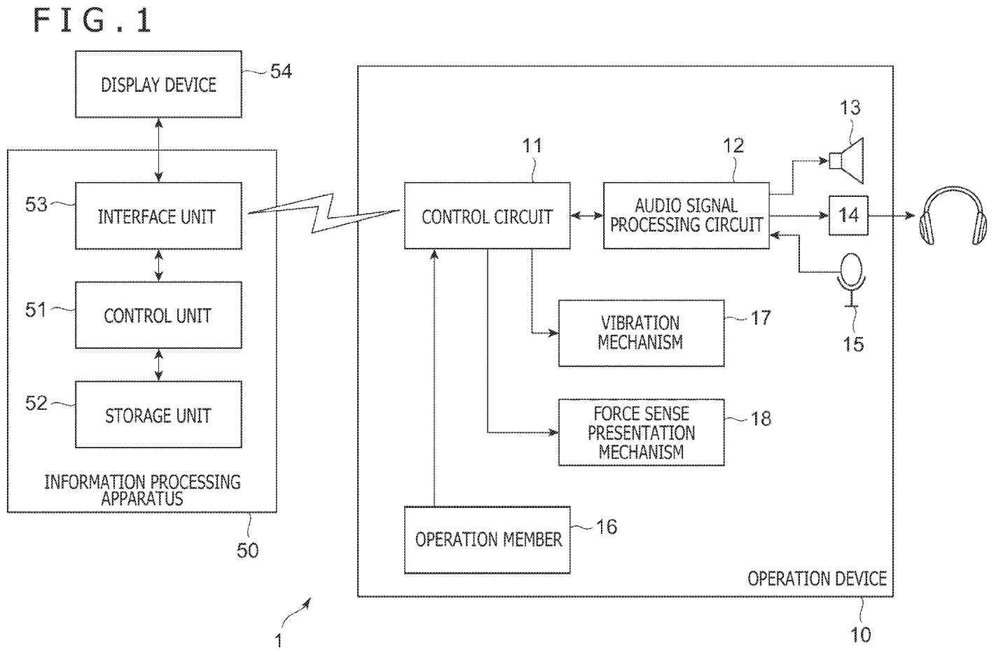

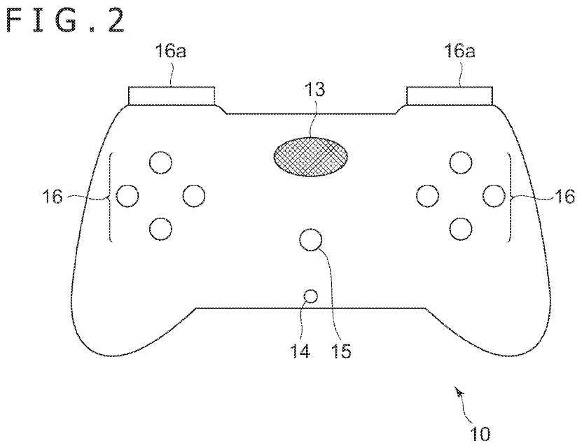

FIG. 1 is an overall configuration diagram of an information processing system 1 according to an embodiment of the present invention. Further, FIG. 2 is a diagram illustrating an example of an external appearance of an operation device 10. As illustrated in these figures, the information processing system 1 includes the operation device 10 and an information processing apparatus 50. In the present embodiment, the operation device 10 and the information processing apparatus 50 transmit and receive data by wireless communication such as a Bluetooth (registered trademark) standard. Incidentally, here, data is transmitted and received by wireless communication but the present invention is not limited to this, and the operation device 10 and the information processing apparatus 50 may be communicably connected by wire according to a standard such as a USB (universal serial bus).

The operation device 10 is a controller for a home-use game machine, for example, and includes a control circuit 11, an audio signal processing circuit 12, a speaker 13, a headphone terminal 14, a microphone 15, a plurality of operation members 16, a vibration mechanism 17, and a force sense presentation mechanism 18.

The control circuit 11 is a microprocessor or the like and executes a process for controlling each part of the operation device 10. To be specific, the control circuit 11 outputs a control signal for operating the vibration mechanism 17, the force sense presentation mechanism 18, and the like according to the control instruction received from the information processing apparatus 50. Further, the control circuit 11 periodically scans a state of each operation member 16 to identify an operation content performed by a user, and transmits the operation information indicating the operation content to the information processing apparatus 50.

Further, the control circuit 11 receives an audio signal for reproduction from the information processing apparatus 50 and transmits this audio signal to the audio signal processing circuit 12. Further, the control circuit 11 receives a collected sound audio signal from the audio signal processing circuit 12 and transmits the collected sound audio signal to the information processing apparatus 50. In order to exchange such various audio signals, the control circuit 11 and the audio signal processing circuit 12 are connected so as to be capable of data communication with each other by an interface standard such as I2S (Inter-IC Sound).

The audio signal processing circuit 12 is a digital signal processor or the like and performs various types of signal processing on a digital audio signal. To be specific, the audio signal processing circuit 12 processes the audio signal for reproduction received from the control circuit 11 to emit a sound from headphones connected to the headphone terminal 14 or the speaker 13. Further, the audio signal processing circuit 12 executes audio signal processing such as noise removal processing on the collected sound audio signal obtained by collecting sound with the microphone 15 and transmits the audio signal to the control circuit 11.

The speaker 13 reproduces sound based on the audio signal for reproduction output by the audio signal processing circuit 12. Headphones can be connected to the headphone terminal 14, and in the case where headphones are connected to the headphone terminal 14, the audio signal processing circuit 12 can also reproduce sound based on the audio signal for reproduction from the headphones instead of the speaker 13.

The microphone 15 collects sound around the operation device 10 such as speech voice of a user who uses the operation device 10. Incidentally, the microphone 15 may be a microphone array including a plurality of microphone elements.

The plurality of operation members 16 are members subject to operation input by the user and may include various types of members. In the present embodiment, the operation members 16 include at least one trigger button 16a.

The trigger button 16a is a member that is operated by the user's pressing motion, and includes a movable portion that moves in response to the user's operation. The trigger button 16a is configured to be capable of measuring the push-in amount (operation amount) as a numerical value. As a result, the content of the pressing operation such as maintaining the state in which the user presses the trigger button 16a slightly or pressing the trigger button 16a to the end quickly can be identified in more detail.

The vibration mechanism 17 is a device that generates vibration and may be various types of devices such as a voice coil motor. Due to the vibration mechanism 17 generating vibration in response to an instruction from the control circuit 11, the vibration is transmitted to a hand of the user holding the operation device 10. Incidentally, the operation device 10 may be provided with a plurality of vibration mechanisms 17, and in that case, the plurality of vibration mechanisms 17 may be ones of types different from each other.

The force sense presentation mechanism 18 is a device that presents a force sense to the user when the user performs an operation on the operation member 16. In the present embodiment, the force sense presentation mechanism 18 includes an arm (force sense presentation member) in contact with the movable portion of the trigger button 16a, and this arm applies a force to the movable portion. As a result, when the user conducts an operation to press the trigger button 16a, the force sense presentation mechanism 18 presents the force sense to the finger that is performing the operation.

Further, in the present embodiment, the force sense presentation mechanism 18 is configured to be able to control the content of the force sense presented according to the position of the movable portion of the trigger button 16a by changing the target position of the arm according to the instruction from the control circuit 11. To be specific, the position of the arm changes depending on the content of the instruction from the control circuit 11 and the force with which the movable portion of the trigger button 16a is pushed by the user's finger. The control circuit 11 is configured to change the control content for the arm according to the change of position of the arm. As a result, the force sense presentation mechanism 18 can change the content of the force sense to be presented to the finger of the user who operates the trigger button 16a, according to how much the operation amount of the trigger button 16a (namely, the push-in amount of the movable portion of the trigger button 16a) is. For example, the force sense presentation mechanism 18 can implement control so as to present the force sense to the user only while the operation amount of the trigger button 16a is included in a given value range, or end the force sense presentation that has been executed until then in the case where the operation amount of the trigger button 16a exceeds a given threshold value.

In the following description, it is assumed that the control circuit 11 divides a control target range of the force sense presentation mechanism 18 (namely, the range in which the position of the arm can be displaced in conjunction with the movable portion of the trigger button 16a) into ten ranges P0 to P9 and control the operation of the force sense presentation mechanism 18 according to in which range of these ranges the position of the arm is included. As a result, the control circuit 11 can change the operation content of the force sense presentation mechanism 18 in ten steps according to how much the user pushes in the trigger button 16a. Note that, here, the range P0 corresponds to the state in which the trigger button 16a is scarcely pushed, and the range P9 corresponds to the state in which the trigger button 16a is pushed to the vicinity of the maximum. Here, the control target range of the force sense presentation mechanism 18 corresponds to the movable range of the movable portion of the trigger button 16a, but a correspondence relation between the control target ranges P0 to P9 of the force sense presentation mechanism 18 and the numerical value of the operation amount of the trigger button 16a is not always constant due to individual differences in a positional relation between the arm and the movable portion of the trigger button 16a of each operation device 10. For example, in the case where the operation amount (push-in amount) of the trigger button 16a is measured in 256 steps from 0 to 255, there may be a case where the operation amount less than 30 of the trigger button 16a corresponds to the control target range P0 of the force sense presentation mechanism 18 in a certain operation device 10, and on the other hand, the operation amount less than 32 corresponds to the range P0 in another operation device 10.

The information processing apparatus 50 is a home-use game machine or a personal computer, for example, and includes a control unit 51, a storage unit 52, and an interface unit 53. Further, the information processing apparatus 50 is connected to the operation device 10 and a display device 54.

The control unit 51 includes at least one processor and executes various types of information processing according to a program stored in the storage unit 52. The storage unit 52 includes at least one storage element and stores a program to be executed by the control unit 51 and data to be processed by the program. The interface unit 53 includes a communication interface for exchanging information with the operation device 10 and the display device 54. The information processing apparatus 50 receives various types of information such as operation information from the operation device 10 via the interface unit 53, and transmits various control instructions to the operation device 10. Further, the interface unit 53 outputs a video signal to be displayed by the display device 54.

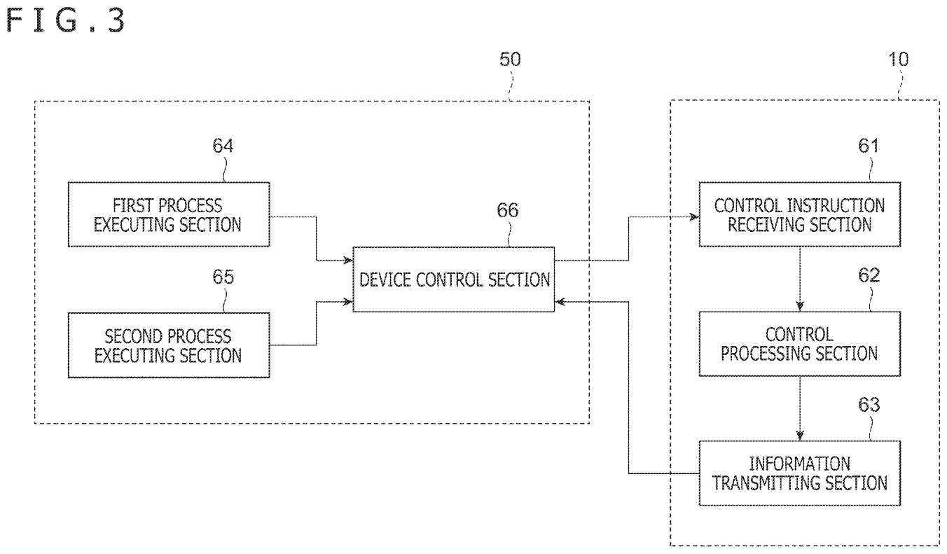

Hereinafter, the functions fulfilled by the operation device 10 and the information processing apparatus 50 in the present embodiment will be described with reference to the functional block diagram of FIG. 3. As illustrated in FIG. 3, the operation device 10 functionally includes a control instruction receiving section 61, a control processing section 62, and an information transmitting section 63. These functions are fulfilled by executing a program built in the control circuit 11. The information processing apparatus 50 functionally includes a first process executing section 64, a second process executing section 65, and a device control section 66. These functions are fulfilled by the control unit 51 executing a program stored in the storage unit 52.

The control instruction receiving section 61 receives a control instruction regarding the operation content of the force sense presentation mechanism 18 from the device control section 66 of the information processing apparatus 50. Here, it is assumed that the control instruction received from the information processing apparatus 50 specifies the operating conditions and the operating contents of the force sense presentation mechanism 18. Further, this operating condition includes a condition relating to the timing at which the force sense presentation mechanism 18 is operated. That is, in the case of receiving the control instruction from the information processing apparatus 50, the control circuit 11 actually does not immediately allow the force sense presentation mechanism 18 to execute the actual operation according to the content thereof and allows the force sense presentation mechanism 18 to execute the operation of the specified contents at the timing when the operation content of the user satisfies the specified operation condition, as described later. It should be noted that in the case where the operation device 10 includes a plurality of trigger buttons 16a and the force sense presentation mechanism 18 is connected to each of them, the control instruction receiving section 61 is assumed to receive a control instruction for each force sense presentation mechanism 18.

The control processing section 62 executes processing according to the control instruction received by the control instruction receiving section 61. To be specific, the control processing section 62 monitors the content of operation of the operation member 12 conducted by the user, and executes control process to cause the force sense presentation mechanism 18 to operate according to the designated operation content in the case where it is determined that the operation content satisfies the specified operation condition.

In particular, in the present embodiment, the control instruction specifies one of a plurality of predetermined operation modes. When the control instruction is received, the control processing section 62 switches to the operation mode specified by the control instruction. After that, control based on the operation mode is performed until an instruction to switch to another operation mode is issued. This operation mode defines the operation content to be executed by the force sense presentation mechanism 18. That is, for each of the plurality of operation modes, it is assumed that the operation content to be executed by the force sense presentation mechanism 18 in the operation mode is defined in advance and recorded in the control circuit 11.

Further, the control processing section 62 is assumed to operate the force sense presentation mechanism 18 in one of a plurality of operating states predetermined corresponding to each operating mode. Here, the control processing section 62 operates the force sense presentation mechanism 18 in an operating state determined according to a change of the operation content of the user. That is, in each operation mode, the force sense presentation mechanism 18 operates in any of the plurality of operation states, and the control processing section 62 controls the transition between the plurality of operation states. At least, the control processing section 62 changes the operation state of the force sense presentation mechanism 18 according to the operation amount of the operation performed by the user with respect to the trigger button 16a. That is, the timing for making the transition of the operating state is determined according to the operation content of the user for the trigger button 16a.

Hereinafter, specific examples of the operation mode will be described. As an example, the control processing section 62 operates the force sense presentation mechanism 18 in the feedback mode. In this operation mode, the control processing section 62 presents the sense of force that repels the pushing operation by the user while the position of movable portion of the trigger button 16a is included in a predetermined area (that is, while the position of the arm is included in a predetermined range of the control target ranges P0 to P9). On the other hand, while the position of the trigger button 16a is not included in the predetermined area, the force sense is not presented. That is, in this operation mode, the control processing section 62 performs a state transition between a state in which the repulsive force is presented and a state in which the repulsive force is not presented, according to the push-in amount of the trigger button 16a.

It should be noted that although the transition is performed only between two types of states here, the control processing section 62 may change the state into a state of presenting a strong force sense or a state of presenting a weak force sense, for example, according to the control target range of the force sense presentation mechanism 18. As a result, control becomes possible such as presenting increasing repulsive force step by step while the pushing operation is continued though no force sense is presented when the user starts to operate the trigger button 16a. In this case, the control processing section 62 makes a transition of the operating state of the force sense presentation mechanism 18 between three or more types of states.

As another example, the control processing section 62 may operate the force sense presentation mechanism 18 in a vibration mode. In this operation mode, the force sense presentation mechanism 18 vibrates the arm and transmits the vibration to the movable portion of the trigger button 16a in contact with the arm, thereby presenting the vibration to the finger of the user during operation. In this example as well, similarly to the feedback mode, a state transition is performed between a state in which vibration is presented and a state in which vibration is not presented, depending on the push-in amount of the trigger button 12. Further, also in this example, similarly to the feedback mode, a transition may be performed between three or more types of states such as a state in which strong vibration is presented and a state in which weak vibration is presented in addition to the state in which vibration is not presented.

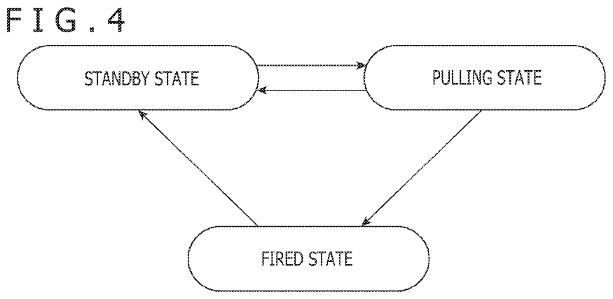

Further, the control processing section 62 may operate the force sense presentation mechanism 18 in a trigger mode. The trigger mode is a mode for simulating an operation for the trigger of a gun or the like, and is, as illustrated in FIG. 4, an operation mode in which a transition is performed between three types of states, namely a standby state, a pulling state, and a fired state. In this trigger mode, the next operating state is determined not only simply according to how much the current operation amount for the trigger button 16a is but also according to which state the current operating state is.

To be specific, the state is the standby state while the trigger button 16a is not operated or the push-in amount is still small after the operation is started (for example, in the case where the position of the arm is in the control target range P0), and in this state, the force sense presentation mechanism 18 does not work. This state corresponds to the state in which the trigger is pulled within a play part.

When the operation amount of the trigger button 16a exceeds a certain threshold value in the standby state, the control processing section 62 makes a transition to the pulling state. This state corresponds to the state in which the trigger of the gun is slowly pulled. For example, the control processing section 62 transitions to the pulling state in the case where the position of the arm is in the control target ranges P1 to P5. In the pulling state, the force sense presentation mechanism 18 presents a force sense in a direction opposite to the user's pushing operation. This gives the user a heavy feeling as if they were pulling an actual trigger.

When the user further continues the push-in operation of the trigger button 16a from the pulling state and the position of the movable portion exceeds a certain threshold value, the control processing section 62 make a transition to the fired state. This state corresponds to the state in which the trigger of the gun is pulled to the end and the bullet is fired. For example, the control processing section 62 makes a transition to the fired state in the case where the position of the arm moves to a position included in the control target ranges P6 to P9 in the pulling state. Even in this state, the force sense presentation mechanism 18 does not perform force sense presentation as in the standby state, and the user can operate the trigger button 16a without feeling any resistance. Note that, after the transition to the fired state is completed once, the fired state remains even if the user releases the pushing operation and the arm moves to a position included in the control target ranges P0 to P5. This makes it possible to imitate the situation of the trigger resistance disappearing after the bullet is fired. It should be noted that in the case where a given condition is satisfied in the fired state such as in the case where the user releases the finger from the trigger button 16a and the operation amount becomes zero, the control processing section 62 makes a transition from the fired state to the standby state. This allows the user to perform the action of triggering the gun again.

In this trigger mode, the control content for the force sense presentation mechanism 18 changes depending on not only the current position of the movable portion of the trigger button 16a but also from what state the situation is transitioning. For example, even in the case where the position of the arm is in the control target range P4, the force sense is presented in the pulling state, and the force sense is not presented after the transition into the fired state. Therefore, there are cases where the information processing apparatus 50 cannot grasp the current state of operation control by a simple notification about the operation amount (push-in amount) of the trigger button 16a from the operation device 10 to the information processing apparatus 50.

Further, although the operation control of the force sense presentation mechanism 18 is executed in conjunction with the position of the movable portion of the trigger button 16a, a correspondence relation between the detection value of the operation amount of the trigger button 16a and the control target range of arm position of the force sense presentation mechanism 18 varies depending on the individual difference of the operation device 10, as described above. Due to such factors, there are cases where it is difficult to identify exactly when the state transition is executed only by the value of the operation amount of the trigger button 16a about which the information processing apparatus 50 is notified. Therefore, in the present embodiment, the information transmitting section 63 of the operation device 10 periodically transmits the current operation mode of the force sense presentation mechanism 18 and the state information indicating the operation state to the information processing apparatus 50.

To be specific, the information transmitting section 63 transmits the operation information indicating a user's operation content with respect to the plurality of operation members 16 (for example, which operation button is pressed and how much the current push-in amount of the trigger button 16a is) at predetermined time intervals. Then, together with this operation information, state information indicating in which a state among the plurality of operating states the control of the force sense presentation mechanism 18 is being executed is transmitted to the information processing apparatus 50. Incidentally, in the case where the operation device 10 includes a plurality of force sense presentation mechanisms 18, state information indicating the current operating state is transmitted for each of the mechanisms. As a result, it is possible to clearly notify the information processing apparatus 50 about the operating state of the force sense presentation mechanism 18, which cannot be identified only by the measured value of the operation amount of the trigger button 16a.

Note that, here, the information transmitting section 63 is supposed to transmit the state information together with the operation information, but the present invention is not limited to this, and the state information may be transmitted at a timing different from that of the operation information. Further, the information transmitting section 63 may transmit the state information at a frequency different from the transmission frequency of the operation information. Further, the information transmitting section 63 may also transmits not only the current operating state but also control position information indicating where the arm position is (for example, which position in the plurality of control target ranges the arm is) together as the state information of the force sense presentation mechanism 18. This control position information indicates at which position the control processing section 62 is currently executing the force sense presentation control.

The application program being executed in the information processing apparatus 50 acquires this operation information and executes various processes according to the contents thereof, as will be described later. This process may include a process of outputting a control instruction for operating the vibration mechanism 17, a process of outputting an audio signal for reproduction, and the like. As a result, the application program can implement control which is linked to the operating state of the force sense presentation mechanism 18, such as reproducing sound from the speaker 13 or causing the vibration mechanism 17 to present vibration at the timing of transition from the pulling state to the fired state in the trigger mode, for example.

The first process executing section 64 and the second process executing section 65 of the information processing apparatus 50 execute processes independent of each other so as to execute various information processing according to the content of the operation input from the user. In the following description, as a specific example, it is assumed that the first process executing section 64 is achieved by executing an application program of a game or the like, and the second process executing section 65 is achieved by executing a system program. Hereinafter, the process implemented by the first process executing section 64 is referred to as a first process, and the process implemented by the second process executing section 65 is referred to as a second process.

These processes run independently of each other. That is, there are cases where the first process and the second process are executed in parallel with each other at the same time, and both processes are allowed to be in the execution state. Then, any one of the processes is selected as the focus process selectively on the basis of a given condition. Here, it is assumed that the focus process is a process to be operated by the user, and the operation information transmitted from the operation device 10 is acquired and processed by the focus process.

The focus process is switched under various conditions. As an example, in the case where the user operates a system button provided on the operation device 10 while the first process executing section 64 is executing the game program, the second process executing section 65 starts the system program and displays the system screen for presenting the processing result on the display device 54. At this time, the focus process is changed from the first process to the second process. After that, when an instruction to end the system screen is issued, the focus process is changed from the second process to the first process. Incidentally, even while the second process is selected as the focus process, the first process operates in the background and continuously executes various processes related to the game.

Under such conditions, the device control section 66 transmits a control instruction for operating the operation device 10 in response to a request from each process, and, at the same time, makes necessary adjustments in response to a change of the focus process. Hereinafter, the contents of control executed by the device control section 66 will be described in detail.

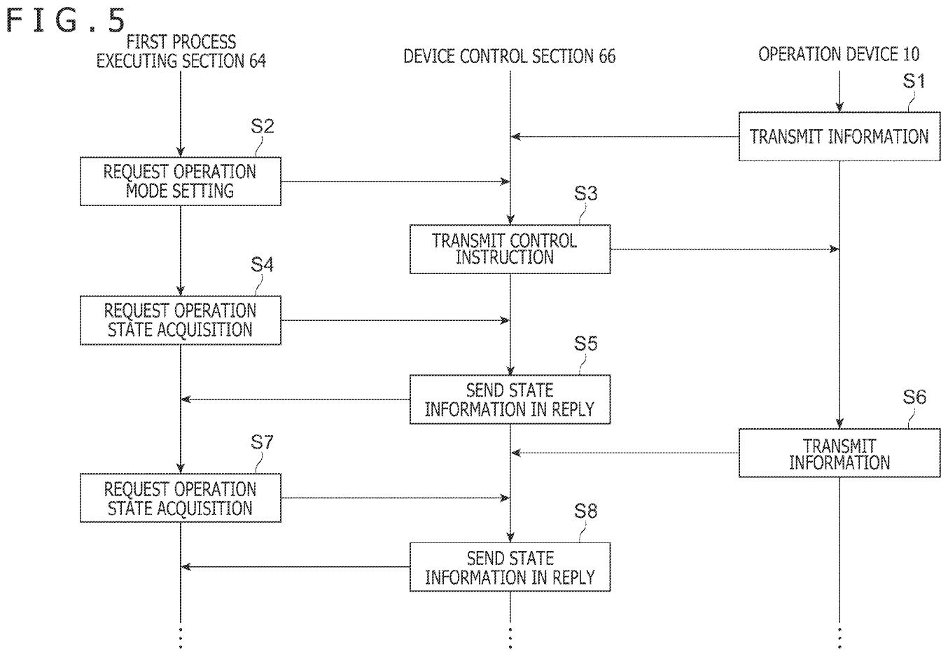

First, an example of the processing flow in the case where only the first process is being executed will be described with reference to the flow chart of FIG. 5. As described above, the information transmitting section 63 of the operation device 10 periodically transmits the operation information and the state information to the information processing apparatus 50. In this figure, transmission of operation information and state information at a certain time point is illustrated by S1.

After that, the first process executing section 64 outputs a request to set the operation mode of the force sense presentation mechanism 18 to the device control section 66 (S2). Here, as an example, it is assumed that the first process executing section 64 requests the operation mode to be changed to the trigger mode because the user becomes able to fire the gun in the game. In response to this request, the device control section 66 transmits, to the operation device 10, a control instruction that instructs the operation device 10 to set the operation mode to the trigger mode (S3). In response to this, the control processing section 62 of the operation device 10 changes the operation mode to the trigger mode. However, as described above, since the information transmission from the operation device 10 to the information processing apparatus 50 is periodically executed, the state information in the new operation mode is not necessarily transmitted to the information processing apparatus 50 immediately after the operation mode is changed. In this example, the first process executing section 64 executes the operation state acquisition request to the device control section 66 before the state information of the new operation mode is transmitted from the operation device 10 (S4). Since the device control section 66 has not acquired the state information of the new operation mode at this stage, the device control section 66 sends the latest past state information transmitted in S1 as a response to the acquisition request in S4 (S5).

After that, the information transmitting section 63 of the operation device 10 transmits new operation information and state information in S6 (S6). Here, the state information in the new operation mode indicated in S3 (for example, the information indicating the standby state in the trigger mode) is transmitted. After that, when the first process executing section 64 makes a request to acquire the operating state again (S7), the device control section 66 sends the state information of the trigger mode transmitted in S6 in reply (S8).

In such a way, the first process executing section 64 outputs an operation mode setting request to the device control section 66 as the process progresses, and then the transition of the operating state executed by the operation device 10 can be known by acquiring the state information periodically transmitted from the operation device 10. Incidentally, in the case where control such as sound reproduction is required in conjunction with the state transition, the first process executing section 64 repeatedly makes inquiries in a short cycle so that such a control is possible.

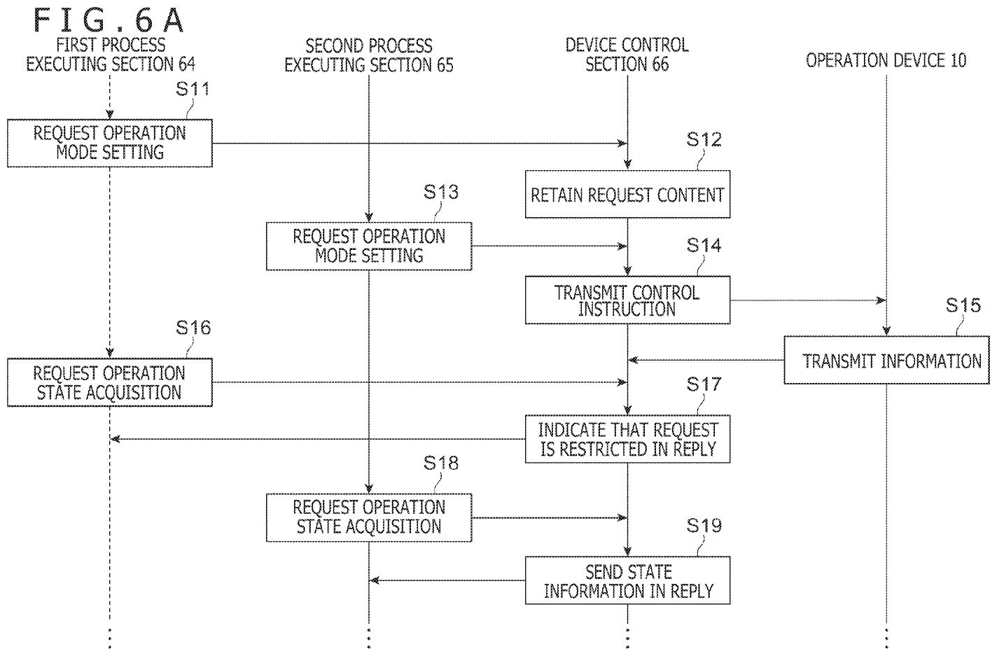

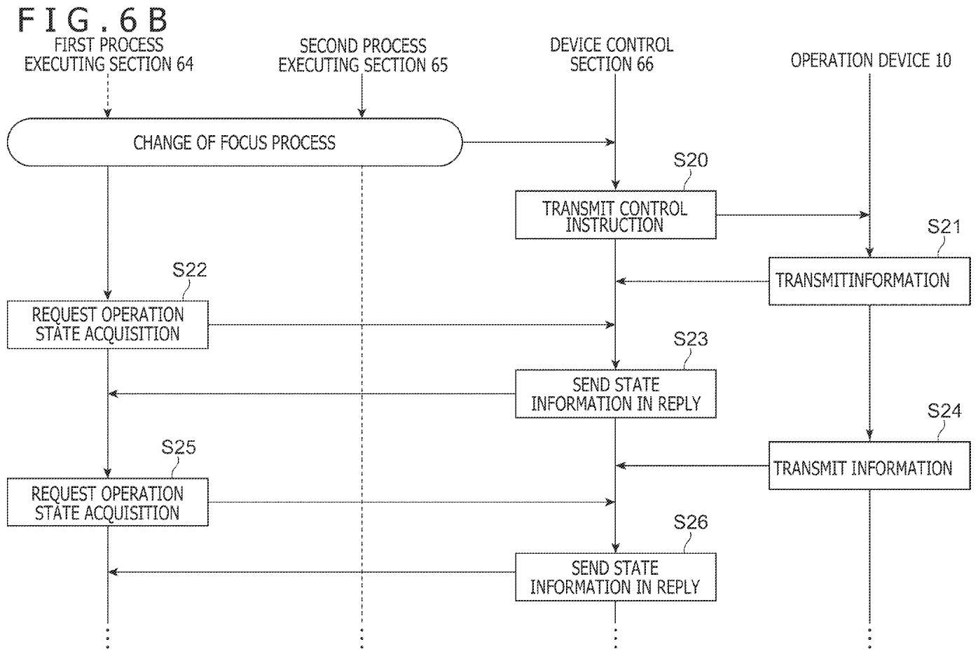

Next, an example of the processing flow in the case where the first process and the second process are executed in parallel will be described with reference to the flow charts of FIGS. 6A and 6B. In this example, it is assumed that the second process is the focus process at first. Note that, in FIGS. 6A and 6B, the executing section which is executing the focus process is indicated by a solid line, and the executing section which is executing the other process is indicated by a broken line as for the first process executing section 64 and the second process executing section 65.

In this example, first, the first process executing section 64 outputs an operation mode setting request (S11). As described above, since a process other than the focus process (here, the first process) is also being executed, there are cases where an operation mode setting request is output according to the progress of the process. However, since the focus process is the second process at this point, if the operation device 10 operates according to the processing content of the first process, there is a risk that the user may be confused. Therefore, the device control section 66 ignores the operation mode setting request from a process other than the focus process and restricts the control instruction for operation mode change to the operation device 10 at this stage. However, the device control section 66 temporarily retains the content of the setting request output by the first process executing section 64 in case the first process becomes the focus process later (S12).

After that, it is assumed that the second process executing section 65 outputs an operation mode setting request (S13). Since the second process is the focus process at this point, the device control section 66 transmits a control instruction for changing the operation mode to the operation device 10 in response to the setting request (S14). At a subsequent timing, information is periodically transmitted from the operation device 10 (S15).

Further, it is assumed that the first process executing section 64 outputs a state information acquisition request following the setting request in S11 (S16). At this time, since the operation mode has not been changed in response to the setting request of S11 and the first process is not the focus process, the device control section 66 indicates that the acquisition request from the first process is restricted in reply (S17).

On the other hand, in the case where the second process executing section 65 outputs a state information acquisition request (S18), since the second process is the focus process, the device control section 66 sends the state information transmitted in S15 to the second process executing section 65 in response to this acquisition request (S19).

After that, it is assumed that the focus process is changed from the second process to the first process by the user performing an operation to terminate the system screen or the like. In response to this change of the focus process, the device control section 66 transmits, to the operation device 10, a control instruction responding to the latest setting request received from the changed focus process and held (here, the setting request having the contents held in S12) (S20). By such control, the operation mode can be switched according to the request of the first process without the first process executing section 64 outputting the operation mode setting request again. Note that, in the case where there is no operation mode setting request received in the past from the changed focus process when the focus process is changed, the device control section 66 may transmit a control instruction to reset the current operation mode to the operation device 10.

In this example, information is transmitted from the operation device 10 immediately after the transmission of the control instruction in S20 (S21). At this point, the change of the operation mode according to the control instruction of S20 is not completed, and the state information corresponding to the operation mode up to that point is transmitted.

When the first process executing section 64 outputs a request for state information acquisition in this state (S22), since the first process has been switched to the focus process this time, the state information transmitted in S21 is provided to the first process (S23). Further, subsequently, the operation mode is changed according to the control instruction transmitted in S20, and the state information in the changed operation mode is transmitted to the device control section 66 (S24). After that, in response to the request for state information acquisition from the first process executing section 64 (S25), the state information in the operation mode requested by the first process executing section 64 in S11 is sent in reply (S26).

As described above, in the case where the information processing apparatus 50 executes a plurality of processes and one of them is selectively switched to the focus process, the device control section 66 outputs a control instruction to change the operation mode according to the request received from the focus process. Due to this, the operation control of the force sense presentation mechanism 18 based on the request of a process different from the focus process which is the current object to which the operation is input for user can be prevented from being performed. Further, the device control section 66 temporarily holds the contents of the operation mode setting request received from a process other than the focus process and transmits the control instruction according to the contents of the held setting request in the case where the process is switched to the focus process. This allows each process to make an operation mode setting request regardless of whether the process is currently the focus process.

As described above, according to the present embodiment, the information processing apparatus 50 can suitably perform control according to the execution state of the operation device 10 or the like.

It is to be noted that the embodiment of the present invention are not limited to those described above. For example, in the above description, the operation device 10 is a controller of a home-use game machine, but the operation device 10 is not limited to this and may be various types of devices that accept user operations.

Further, in the above description, the control processing section 62 makes a transition of the operating state of the force sense presentation mechanism 18 according to the operation amount of the user with respect to the trigger button 16a, but the present invention is not limited to this, and may control the operation content of the force sense presentation mechanism 18 according to the content of the user's operation with respect to various operation members. Further, the control processing section 62 may control the operation contents of various mechanisms such as the vibration mechanism 17 according to the user's operation on the operation member included in the operation device 10, without limiting to the operation control of the force sense presentation mechanism 18. In either case, the information transmitting section 63 periodically transmits state information indicating what kind of control is currently being executed for each mechanism to the information processing apparatus 50, so that the information processing apparatus 50 can execute processing according to the control state of the operation device 10 at an appropriate timing.

### REFERENCE SIGNS LIST

1: Information processing system
10: Operation device
11: Control circuit
12: Audio signal processing circuit
13: Speaker
14: Headphone terminal
15: Microphone
16: Operation member
16a: Trigger button
17: Vibration mechanism
18: Force sense presentation mechanism
50: Information processing apparatus
51: Control unit
52: Storage unit
53: Interface unit
54: Display device
61: Control instruction receiving section
62: Control processing section
63: Information transmitting section
64: First process executing section
65: Second process executing section
66: Device control section

1. An information processing apparatus connected to an operation device, the information processing apparatus comprising:
a process executing section that executes a plurality of processes in parallel; and
an operation device control section that transmits, to the operation device, a control instruction that indicates a content of a control process to be executed by the operation device, wherein
the operation device control section transmits the control instruction in response to a setting request received from a selected process selected from the plurality of processes according to a given condition, and restricts transmission of the control instruction in response to a setting request received from a process different from the selected process.

2. The information processing apparatus according to claim 1, wherein the operation device control section selects a process that is an object for accepting a user's operation from the plurality of processes as the selected process.

3. The information processing apparatus according to claim 1, wherein the operation device control section periodically receives state information indicating an execution state of the control process from the operation device, and provides the state information in response to an acquisition request received from the selected process, and restricts provision of the state information in response to an acquisition request received from the process different from the selected process.

4. The information processing apparatus according to claim 1, wherein, when restricting the transmission of the control instruction in response to the setting request received from the process different from the selected process, the operation device control section retains a content of the setting request, and transmits the control instruction in response to the retained setting request when the different process is newly selected as the selected process.

5. A method for controlling an information processing apparatus connected to an operation device, the method comprising:
executing a plurality of processes in parallel; and
transmitting, to the operation device, a control instruction indicating a content of a control process to be executed by the operation device, wherein
the transmitting includes transmitting the control instruction in response to a setting request received from a selected process selected from the plurality of processes according to a given condition and restricting transmission of the control instruction in response to a setting request received from a process different from the selected process.

6. A non-transitory, computer readable storage medium containing a computer program, which when executed by a computer connected to an operation device, causes the computer to carry out actions, comprising:
executing a plurality of processes in parallel; and
transmitting, to the operation device, a control instruction indicating a content of a control process to be executed by the operation device,
wherein the transmitting includes transmitting the control instruction in response to a setting request received from a selected process selected from the plurality of processes according to a given condition and restricting transmission of the control instruction in response to a setting request received from a process different from the selected process.
